(19) United States
(12) Patent Application Publication
(10) Pub. No.: US 2012/0298245 A1
(43) Pub. Date: Nov. 29, 2012

(54) DIVERLESS SUBSEA CONNECTION

(75) Inventors: Michael Hosokawa Dupre, Houston, TX (US); Donald Christopher Nelson, Cypress, TX (US)

(73) Assignee: SHELL OIL COMPANY, Houston, TX (US)

(21) Appl. No.: 13/575,428

(22) PCT Filed: Jan. 25, 2011
(86) PCT No.: PCT/US2011/022318

§ 371 Date: Jul. 26, 2012

Related U.S. Application Data
(60) Provisional application No. 61/298,932, filed on Jan. 28, 2010.

(51) Int. Cl. F16L 3/00; B23P 17/00

(52) U.S. Cl. 138/106; 137/15.01

(57) ABSTRACT

A method of making a connection in a subsea pipeline, comprising lowering a foundation over a section of the pipeline; cutting the out a section of the pipeline to form an end of a first pipeline and an end of a second pipeline; connecting a first hub to the end of the first pipeline; connecting a second hub to the end of the second pipeline; connecting a first port to the first hub; connecting a second port to the second hub; and connecting a jumper between the first port and the second port.

### BACKGROUND OF INVENTION

1. Field of the Invention

This invention is directed to subsea pipe connections.

2. Background Art

U.S. Patent Application Publication 2009/026765 discloses a method of connecting pipe ends of two subsea pipes using a jumper including raising two separate ends of two separate pipelines from an initial position of each of the two separate ends; creating a jumper pipe; welding a flange with a landing saddle to each pipeline end; disposing a predetermined number of cylinders at a predetermined interval offset with respect to each of the cylinders; connecting a cylinder end to a first leg of the jumper pipe; connecting a rod end to a second leg of the jumper pipe; using the cylinders to contract the jumper in a predetermined plane so that the flanges clear the pipe ends but not the flange saddles; supporting the jumper by a spreader bar; lowering the jumper over the pipeline such that the flange saddles rest on the pipeline ends; relaxing at least one of the cylinders so the jumper expands in the predetermined plane, driving the flanges onto the pipeline ends; releasing the spreader bar; and lowering the pipeline ends and jumper to a predetermined position. U.S. Patent Application Publication 2009/026765 is herein incorporated by reference in its entirety.

WO Patent Application Publication 2008/155747 discloses a pipeline alignment termination device comprises a connecting piece connected at its first end to a pipeline. The connecting piece is supported on a skid base by an articulated support. Adjustable constraints operable by ROV, permit the second end to be accurately aligned by transverse and rotational adjustments with the end of a spoolpiece. After alignment and connection, constraints on the rotation and transverse movement are removed, leaving the connecting piece supported but free to move with up to five degrees of freedom. WO Patent Application Publication 2008/155747 is herein incorporated by reference in its entirety.

WO Patent Application Publication 2008/021792 discloses a subsea hot-tapping system, comprising an existing pipeline; a hot-tap body fitted around the pipeline; and a fluid injected between the pipeline and the body. In some embodiments, the system also includes a radial arm cutter, adapted to cut a hole in the existing pipeline. WO Patent Application Publication 2008/021792 is herein incorporated by reference in its entirety.

There is a need in the art for one or more of the following:

Improved systems and methods for connecting to ends of a subsea pipeline.

Improved systems and methods for connecting a new pipeline to an existing pipeline.

Improved systems and methods for connecting pipelines without the use of a diver.

Improved systems and methods for connecting pipelines in deeper water.

Improved systems and methods for connecting pipelines that allow for relative movement between the pipelines.

### SUMMARY OF THE INVENTION

One aspect of the invention provides a method of connecting two subsea pipelines to each other, comprising lowering a foundation over an end of a first pipeline and over an end of a second pipeline; connecting a first hub to the end of the first pipeline; connecting a second hub to the end of the second pipeline; connecting a first port to the first hub; connecting a second port to the second hub; and connecting a jumper between the first port and the second port.

### BRIEF DESCRIPTION OF THE DRAWINGS

FIG. 1 is an example of a subsea pipeline in accordance with embodiments disclosed herein.

FIG. 2 is a perspective view of a subsea connection in accordance with embodiments disclosed herein.

FIG. 3 is a perspective view of a subsea connection in accordance with embodiments disclosed herein.

FIG. 4 is a perspective view of exemplary subsea connection equipment in accordance with embodiments disclosed herein.

FIG. 5 is a perspective view of a subsea connection in accordance with embodiments disclosed herein.

FIG. 6 is a perspective view of a subsea connection during installation in accordance with embodiments disclosed herein.

FIG. 7 is a perspective view of a portion of a subsea connection during installation in accordance with embodiments disclosed herein.

### DETAILED DESCRIPTION

In one aspect, embodiments disclosed herein relate to a system and method for diverless subsea connections. More specifically, embodiments disclosed herein relate to a system and method for making diverless subsea connections on the seafloor.

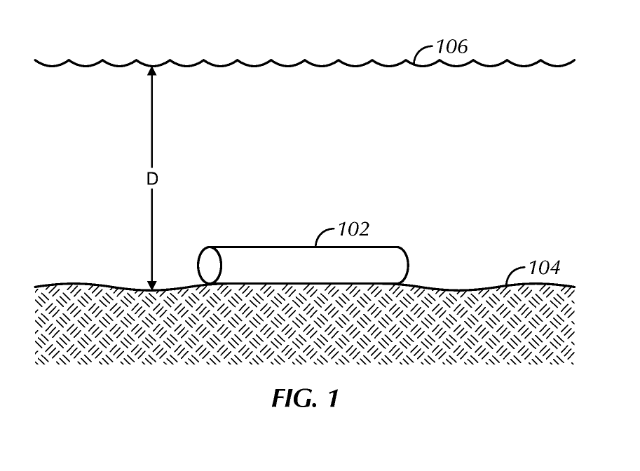

FIG. 1:

Referring to FIG. 1, a main pipeline 102 is disposed on a seafloor 104 as shown wherein fluid may flow from one end of main pipeline 102 to a second end of main pipeline 102. Seafloor 104 may be disposed in a deep sea zone. For example, seafloor 104 may be located at a depth, D, more than 3000, 5000, or even 7000 feet below the water surface 106.

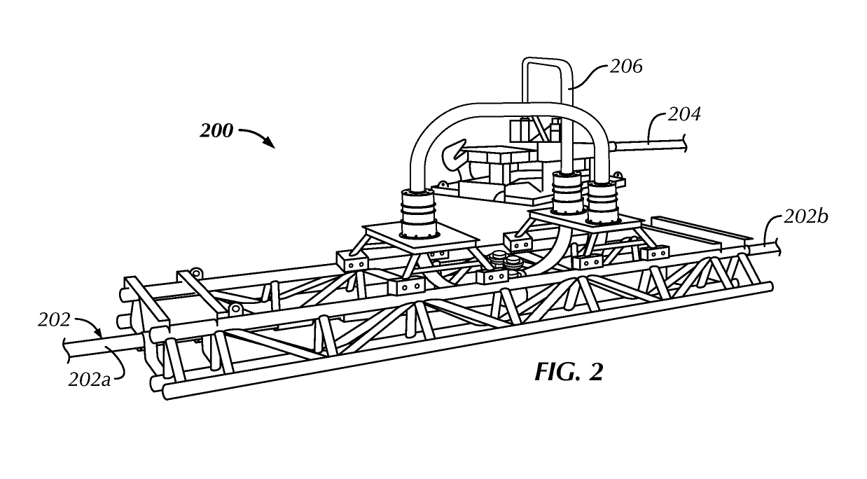

FIG. 2:

Referring now to FIG. 2, a completed subsea connection 200 in accordance with embodiments disclosed herein is shown. Subsea connection 200 is shown disposed between a first portion 202a and a second portion 202b of main pipeline 202. In certain embodiments, fluid may flow from first portion 202a, through subsea connection 200, and into second portion 202b of main pipeline 202. Additionally, a second fluid source may be connected to subsea connection 200 such that a second fluid may flow through subsea connection 200 and into second portion 202b of main pipeline 200. In the exemplary subsea connection 200 shown, a secondary pipeline 204 may be connected to subsea connection 200 by a secondary jumper 206. Exemplary subsea connection 200, and one method for installing subsea connection 200, will be described in detail below.

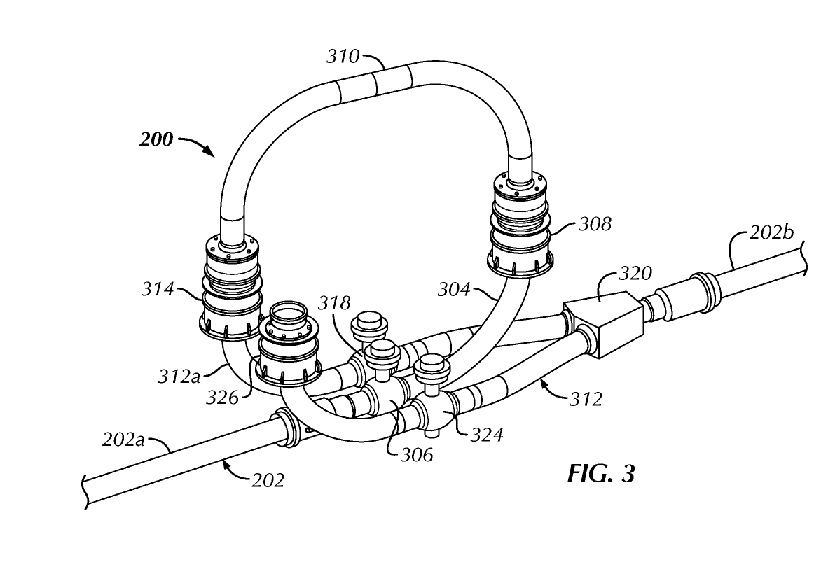

FIG. 3:

Referring to FIG. 3, a detailed view of exemplary subsea connection 200 is shown. First portion 202a of main pipeline 202 is shown connected to a single hub assembly 304 having a valve 306 and a first port 308. As used herein, a port refers to a connection that connects two fluid passages, i.e., pipes or tubulars. A first jumper 310 may be connected to single hub assembly 304 at one end by first port 308 and may be connected to a dual hub assembly 312 by a second port 314 disposed on dual hub assembly 312. Dual hub assembly 312 may have a first conduit 312a and a second conduit 312b. Second conduit 312b may have a third port 326 disposed thereon. In certain embodiments, first, second, and third ports 308, 314, 326 may be integrally formed with single hub assembly 304, jumper 310, and/or dual hub assembly 312. In other embodiments, first, second, and third ports 308, 314, 326 may be components separate from single hub assembly 304, jumper 310, and dual hub assembly 312 that may be threadingly engaged with, welded to, or otherwise connected to single hub assembly 304, jumper 310, and dual hub assembly 312.

During use, fluid may flow from first portion 202a of main pipeline 202 into single hub assembly 304, and into jumper 310. The fluid may then flow through flow converger 320 and into second portion 202b of main pipeline 202. Flow of fluid through dual hub assembly 312 may be controlled by valves 318, 324. As shown, dual hub assembly 312 includes two conduits 312a, 312b, but one of ordinary skill in the art having benefit of this disclosure will appreciate that any number of conduits may be added to subsea connection 200 without departing from the scope of the present application.

In certain embodiments, it may be desirable to close valve 324 such that fluid may flow from first portion 202a of main pipeline 202 through subsea connection 200 to second portion 202b of main pipeline 202. In other embodiments, a secondary pipeline (not shown) from another wellsite or location may be connected to third port 326. In this embodiment, at least one of valves 306, 318 may be closed and valve 324 opened such that fluid from the secondary pipeline may flow through second conduit 312b and into main pipeline 202. One of ordinary skill in the art will appreciate that valves 306, 318, 324 may be positioned such that fluid may flow through first conduit 312a and/or second conduit 312b. Additionally, valves 306, 318, 324 may be positioned to allow a desired amount of fluid through first conduit 312a and second conduit 312b. In certain embodiments, ROVs may be used to adjust the position of valves 306, 318, 324. In some embodiments, suitable valves 306, 318, 324 are welded body ball valves commercially available from Cooper Cameron Valves of Houston, Tex., for example an 18″ ANSI 1500 Welded Body Ball Valve with direct drive ROV API Class 5 Interface.

One of ordinary skill in the art will appreciate that additional dual hub assemblies, conduits, and/or jumpers may be connected such that more than one secondary pipeline may be tied in to main pipeline 202. The hub assemblies, conduits, jumpers, and ports may have a modular design, thereby allowing the hub assemblies, conduits, jumpers, and ports to be assembled in such a way that multiple secondary pipelines may be tied in to main pipeline 202, such as 1-5 additional pipelines, for example 2-4 additional pipelines.

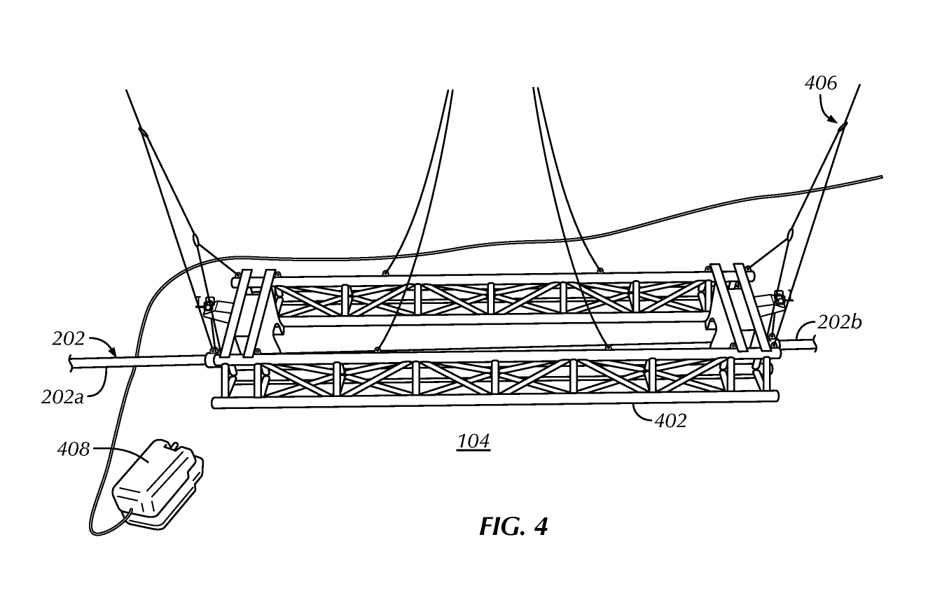

FIG. 4:

Referring now to FIG. 4, a foundation 402 is shown disposed on seafloor 104 and in alignment with main pipeline 202. In some embodiments, foundation 402 may be lowered onto seafloor 104 and positioned in alignment with main pipeline 202 using a system of cables and winches 406. A remote operated vehicle (ROV) 408 may be used to align foundation 402 with main pipeline 202. Additionally, as shown, foundation 402 may be lowered onto seafloor 104 without carrying components of subsea connection 200. Flow through main pipeline 202 may be sealed off using a pipeline pig train. For example, a pipeline pig train utilizing a series of four 18″ diameter×50″ length Knapp Ultra-Seal pipeline pigs each separated by a 1500′ long seawater slug. The water between the first two pigs is assumed to be contaminated with residual oil from the pipeline. The subsequent water slugs (between pigs 2/3 and 3/4) are assumed to be clean. The connection may be made between pigs 2/3. Once flow has been sealed off, a section of pipe may be cut from main pipeline 202 using ROV 408. The cut section of main pipeline 202 may then be removed, thereby leaving a gap between first portion 202a and second portion 202b of main pipeline 202.

Once foundation 402 is positioned at a desired location and secured, components of subsea connection 200 and other tools and devices may be loaded onto foundation 402. The foundation 402 may be pulled down into position as a buoyant structure with ROV operated winches attached to the pipeline by clamps. Once in position the foundation 402 may be internally flooded with seawater transitioning from a buoyant structure to a gravity based structure. In select embodiments, the loading of tools, devices, and/or components of subsea connection 200 may be achieved using cables and winches 406 to guide elements into position on foundation 402.

FIG. 4 also shows an example of a ROV 408 that may be used in positioning foundation 402, or may be used during the positioning of other elements on foundation 402. ROV 408 may include one or more arms, pressure measurement devices, temperature measurement devices, light sources, and/or imaging devices capable of relaying images, video, and/or data to an operator (not shown). Additionally, although ROV 408 is shown having a tethered connection 410, one of ordinary skill in the art will appreciate that wireless communication may also be used. The ROV 408 may be used to provide three primary functions during the connection. The ROV 408 may provide visual images of the execution of the connection to the support vessel. The ROV 408 can also be the means of deployment of the tooling packages which will be used to cut the pipeline, prepare the pipe ends, and check the ovality of the pipe. The actuation of connection, including setting of the connector seals, actuation of hydraulic cylinders to move components on the frame, and provision of hydraulic pressure to operate tooling; may also be provided by the ROV 408.

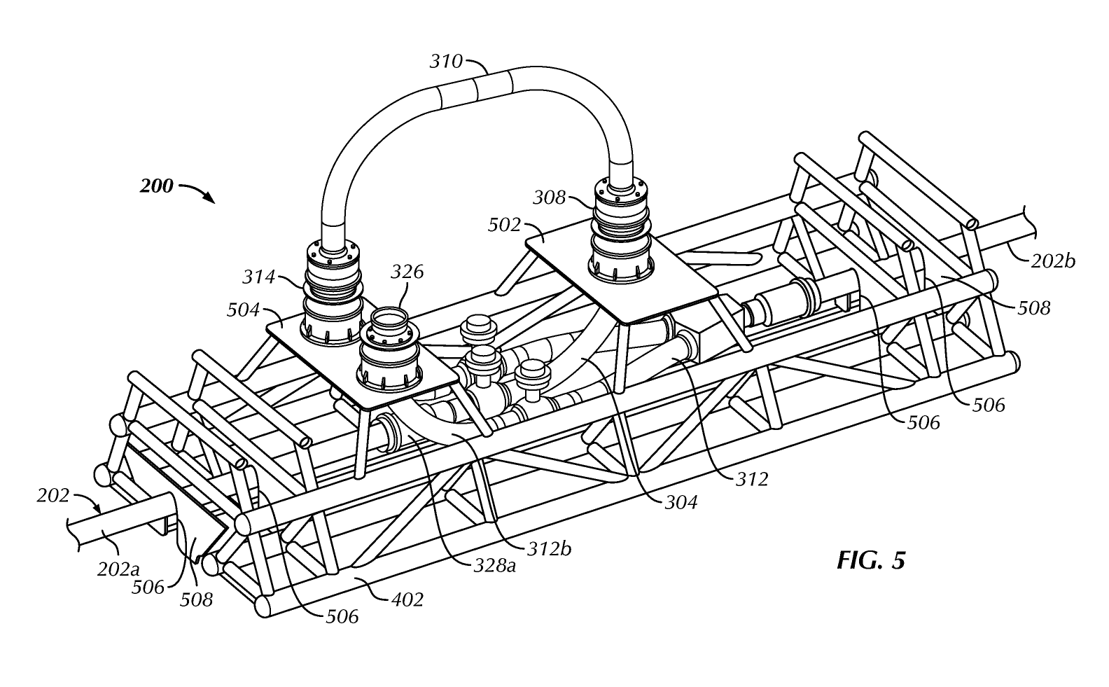

FIG. 5:

Referring to FIG. 5, subsea connection 200 is shown assembled in foundation 402. Foundation 402 may include a plurality of slots 506 formed in transverse ribs 508 into which main pipeline 202 may fit. Slots 506 may reduce relative movement between foundation 402 and main pipeline 202 during installation of subsea connection 200. Additional support structures such as, for example, a first platform 502 and a second platform 504, may be used to stabilize components of subsea connection 200. In the exemplary embodiment shown in FIG. 5, first platform 502 may support single hub assembly 304 while second platform 504 may support dual hub assembly 312.

First and second platforms 502, 504 may reduce or prevent relative movement between components of subsea assembly 200 and foundation 402.

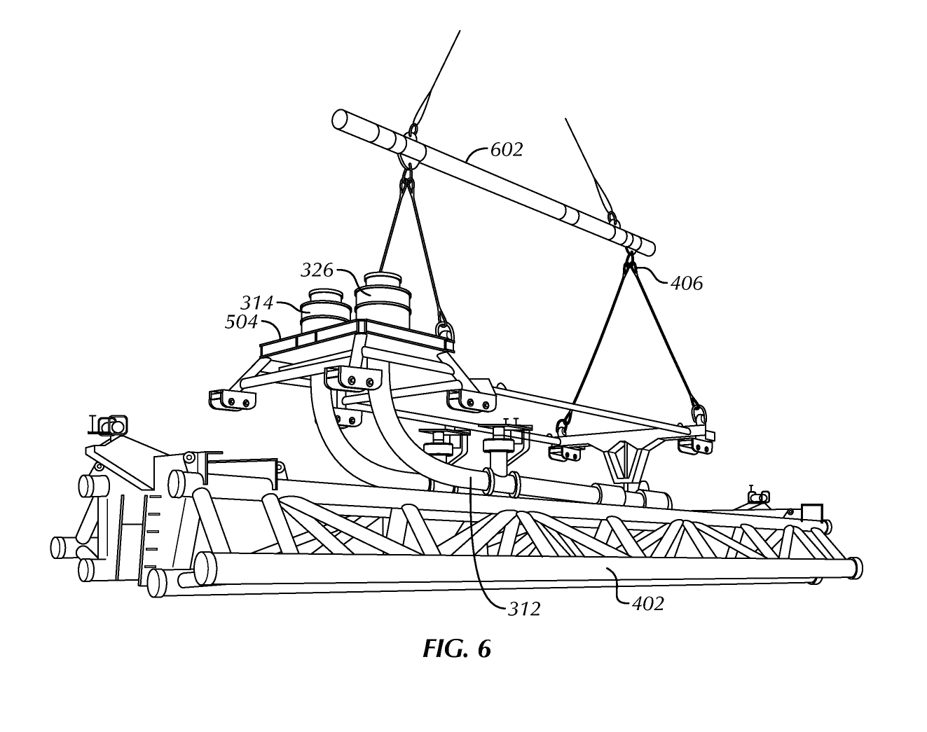

FIG. 6:

Referring now to FIG. 6, an exemplary method of loading a component onto foundation 402 is shown. In FIG. 6, dual hub assembly 312 is shown connected to second platform 504 and being loaded onto foundation 402 using a loading bar 602 in combination with cables and winches 406. Cables and winches 406 may provide assistance in guiding components into a desired position on foundation 402. Once positioned on seafloor 104, ROV (not shown) may secure dual hub assembly 312 to foundation 402 using any means known in the art, such as, for example, bolts, welds, adhesives, etc. Assembly 312 is landed onto the top cord of foundation 402 and retained by negative weight. ROV attaches horizontally oriented hydraulically actuated (by ROV) cylinders between 312 and 402 such that 312 can be pushed or pulled into position. Assembly 312 has a series of v-shaped rollers attached to vertical diagonal legs which allow it to roll on top cord of 402.

One of ordinary skill in the art will appreciate that the order of loading components onto foundation 402 may be varied without departing from the scope of the present disclosure. For example, single hub assembly 304 may be loaded onto foundation 402 before, after, or simultaneously with jumper 310 and dual hub assembly 312.

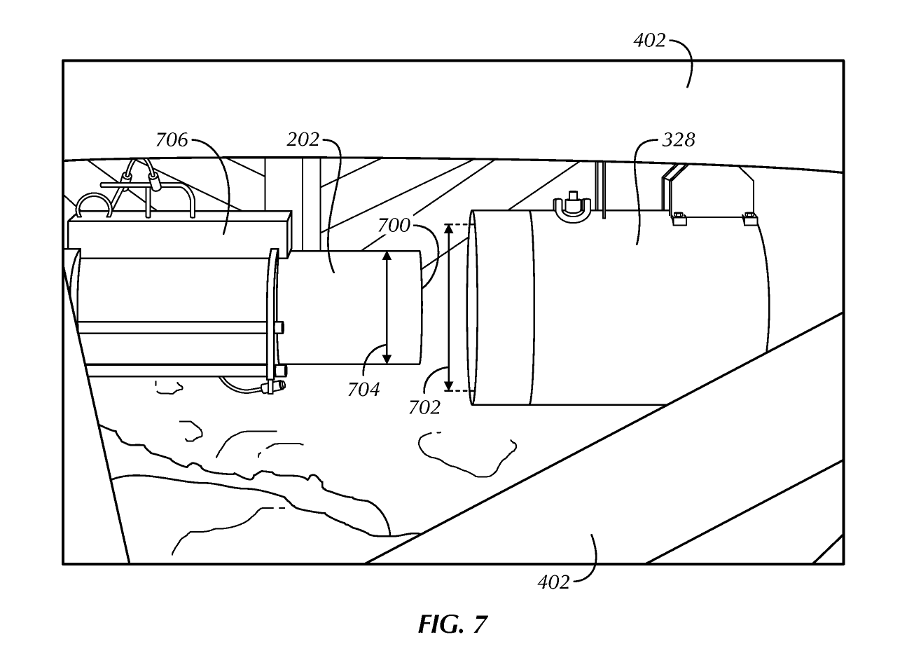

FIG. 7:

Now referring to FIG. 7, a detailed view of main pipeline 202 is shown. Specifically, end 700 may have been formed due to the cutting and removal of a section of pipe from main pipeline 202. End 700 of main pipeline 202 may be supported with a brace 706 such that end 700 of main pipeline 202 may be held in alignment with foundation 402. Main pipeline connector 328 of a subsea connection (not shown) may have an inner diameter 702 designed to fit around outer diameter 704 of end 700 of main pipeline 202 during hook-up of a subsea connection with main pipeline 202. Once positioned such that a portion of main pipeline 202 is disposed inside of main pipeline connector 328, the space between an outer surface of main pipeline 202 and an inner surface of main pipeline connector 328 may be sealed using any means known in the art such as, for example, a threaded connection, o-rings, welds, adhesives, or any combination thereof. In certain embodiments, a pair of ANSI 1500 18 inch Grip and Seal connectors may be used to connect main pipeline connector 328 with end 700 of main pipeline 202. Additionally the ROV measures the pitch, yaw, elevation and lateral position of main pipeline connector 328 relative to main pipeline 202 and adjusts both accordingly. ROV also powers hydraulic cylinders to thrust 328 over 202 and hydraulically actuates and tests 328.

Referring back to FIG. 3, once the single hub assembly 304, jumper 310, and dual hub assembly 312 are in place, and all connections are sealed, a number of tests may be performed on subsea connection 200 by the ROV. For example, a series of pressure tests may be performed to check for leaks at various points in subsea connection 200. The ROV may relay information and test results back to a remote operator who may determine how to proceed based on the test results. Alternatively, the ROV may use on-board equipment to interpret test results and to determine how to proceed based on the test results. When it is determined that all connections of subsea connection 200 are adequately sealed and that all valves are working, desired valves may be opened, thereby allowing fluid to flow through subsea connection 200.

### Alternative Embodiments

Advantageously, embodiments disclosed herein may provide a system and method for completing a subsea connection on a pipeline while it is located on a seafloor. Accordingly, embodiments disclosed herein may provide a method for completing a subsea connection that may decrease the downtime of a main pipeline, decrease time required for on-site fabrication, and decrease installation time, while providing cost savings. Additionally, embodiments disclosed herein may also allow for subsea connections to be made at increased depths and without the use of divers. In certain embodiments, ROVs may perform a portion of the installation of the subsea connection.

Further, embodiments disclosed herein may advantageously provide a subsea connection system that may be adapted to include additional piping spools. The subsea connection disclosed may be modified to accept multiple configurations over time. Additionally, if desired, any or all of the piping spools may be removed from the main pipeline.

### Illustrative Embodiments

In one embodiment, there is disclosed a method of connecting two subsea pipelines to each other, comprising lowering a foundation over an end of a first pipeline and over an end of a second pipeline; connecting a first hub to the end of the first pipeline; connecting a second hub to the end of the second pipeline; connecting a first port to the first hub; connecting a second port to the second hub; and connecting a jumper between the first port and the second port. In some embodiments, the method also includes connecting a valve between the first hub and the end of the first pipeline. In some embodiments, the method also includes connecting a valve between the second hub and the end of the second pipeline. In some embodiments, the method also includes connecting a flow converger between the second hub and the end of the second pipeline. In some embodiments, the method also includes a third hub to the flow converger, and connecting a third port to the third hub. In some embodiments, the method also includes connecting an end of a third pipeline to the third port.

In one embodiment, there is disclosed a method of making a connection in a subsea pipeline, comprising lowering a foundation over a section of the pipeline; cutting the out a section of the pipeline to form an end of a first pipeline and an end of a second pipeline; connecting a first hub to the end of the first pipeline; connecting a second hub to the end of the second pipeline; connecting a first port to the first hub; connecting a second port to the second hub; and connecting a jumper between the first port and the second port. In some embodiments, the method also includes connecting a valve between the first hub and the end of the first pipeline. In some embodiments, the method also includes connecting a valve between the second hub and the end of the second pipeline. In some embodiments, the method also includes connecting a flow converger between the second hub and the end of the second pipeline. In some embodiments, the method also includes connecting a third hub to the flow converger, and connecting a third port to the third hub. In some embodiments, the method also includes connecting an end of a third pipeline to the third port.

In one embodiment, there is disclosed a subsea pipeline connection system comprising a foundation installed on a sea floor over a first pipeline and a second pipeline; the first pipeline comprising an end and the second pipeline comprising an end; a first hub connected to the end of the first pipeline; a second hub connected to the end of the second pipeline; a first port connected to the first hub; a second port connected to the second hub; and a jumper connected between the first port and the second port.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A method of connecting two subsea pipelines to each other, comprising:
lowering a foundation over an end of a first pipeline and over an end of a second pipeline;
connecting a first hub to the end of the first pipeline;
connecting a second hub to the end of the second pipeline;
connecting a first port to the first hub;
connecting a second port to the second hub; and
connecting a jumper between the first port and the second port.

2. The method of claim 1, further comprising connecting a valve between the first hub and the end of the first pipeline.

3. The method of claim 1, further comprising connecting a valve between the second hub and the end of the second pipeline.

4. The method of claim 1, further comprising connecting a flow converger between the second hub and the end of the second pipeline.

5. The method of claim 4, further comprising connecting a third hub to the flow converger, and connecting a third port to the third hub.

6. The method of claim 5, further comprising connecting an end of a third pipeline to the third port.

7. A method of making a connection in a subsea pipeline, comprising:
lowering a foundation over a section of the pipeline;
cutting the out a section of the pipeline to form an end of a first pipeline and an end of a second pipeline;
connecting a first hub to the end of the first pipeline;
connecting a second hub to the end of the second pipeline;
connecting a first port to the first hub;
connecting a second port to the second hub; and
connecting a jumper between the first port and the second port.

8. The method of claim 7, further comprising connecting a valve between the first hub and the end of the first pipeline.

9. The method of claim 7, further comprising connecting a valve between the second hub and the end of the second pipeline.

10. The method of claim 7, further comprising connecting a flow converger between the second hub and the end of the second pipeline.

11. The method of claim 10, further comprising connecting a third hub to the flow converger, and connecting a third port to the third hub.

12. The method of claim 11, further comprising connecting an end of a third pipeline to the third port.

13. A subsea pipeline connection system comprising:
a foundation installed on a sea floor over a first pipeline and a second pipeline;
the first pipeline comprising an end and the second pipeline comprising an end;
a first hub connected to the end of the first pipeline;
a second hub connected to the end of the second pipeline;
a first port connected to the first hub;
a second port connected to the second hub; and
a jumper connected between the first port and the second port.
